(19) United States
(12) Patent Application Publication
(10) Pub. No.: US 2024/0070754 A1
(43) Pub. Date: Feb. 29, 2024

(54) LANGUAGE TRANSLATOR SYSTEM

(71) Applicants: Ali Omrani, San Jose, CA (US); Arash Alahgholipouromrani, San Jose, CA (US)

(72) Inventors: Ali Omrani, San Jose, CA (US); Arash Alahgholipouromrani, San Jose, CA (US)

(21) Appl. No.: 18/458,687

(22) Filed: Aug. 30, 2023

Related U.S. Application Data
(60) Provisional application No. 63/374,080, filed on Aug. 31, 2022.

(51) Int. Cl. G06Q 30/0601; G06Q 20/02; G06Q 30/018; G06Q 30/0282; H04L 67/14

(52) U.S. Cl. CPC G06Q 30/0631; G06Q 20/027; G06Q 30/018; G06Q 30/0282; H04L 67/14

(57) ABSTRACT

The system links a user requesting language translations (“Requesters”) with language translators (“Translators”). Requesters and Translators set up an account with a server. A Requester requests a translation between two languages for a document or speech. The server looks up translators who can perform the translation and then sends the names, and costs, ratings, for each. The Requester chooses one which is directed to a streaming platform session. The Requester's financial account is charged. The Requester and Translator are both linked to the same room of a streaming platform to have a video meeting. Alternatively, they can meet on the phone or chat. After the session ends, the amount charged to the Requester is adjusted for session length. Translator is paid from a financial account of Requester. The Requestor rates the Translator. The accumulated ratings are provided to the next Requester when he/she is selecting a Translator.

### CROSS-REFERENCE TO RELATED APPLICATIONS

This application claims priority to U.S. Provisional Patent Application 63/374,080 with the same title, filed Aug. 31, 2022, and incorporates it as if set forth in its entirety here, to the extent that it does not conflict with this application.

### FIELD

The current invention relates to a system for linking people desiring language translations with live language translators and, more specifically, a system for linking people desiring language translations with a live language translator and managing the financial transaction.

### BACKGROUND

The history of translation has been a topic that scholars and historians have long debated. It is known that translation was carried out as early as the Mesopotamian era when the Sumerian poem, Gilgamesh, was translated into Asian languages. Language translations date back to around the second millennium BC. Other translated ancient works include those carried out by Buddhist monks who translated Indian documents into Chinese. In later periods, Ancient Greek texts were also translated by Roman poets and were adapted to create developed literary works for entertainment. It is known that translation services were utilized in Rome by Cicero and Horace and that these uses continued through to the 17th century when newer practices were developed.

The need for translation became greater with the development of religious texts and spiritual theories. As religion developed, the desire to spread the word and encourage faith meant that religious texts needed to be available in multiple languages. One of the first translated religious texts is known to have been that of the Old Testament, which was translated into Greek in the 3rd century BC.

Following the Industrial Revolution, the economy developed rapidly and evolved into a machine with the potential for global success. New machinery allowed for swifter production of texts and business-related materials, which means that more time could be invested in evolving a company and translating material to enter foreign markets. Since the 18th century, businesses have benefitted from formalized translation services, but the dawn of modern practice came with the widespread introduction of the internet.

The internet has revolutionized the ability to access, translate and understand texts and documents from all over the world, whether they be contemporary or historical pieces. Crucially, the need to understand the culture of the original country and that of the target audience is further enhanced by modern tools and practices. These days, machine translation trained based on machine learning algorithms can achieve accuracy close to human translation. However, machine translation can still not be used for legal and medical purposes as the lack of human accuracy can cause serious problems. In addition, the best machine translation services can cover translation from about 70 languages, while there are about 7000 languages around the world which can be fully covered by human translation services.

The more the world is connected, the more the language becomes a barrier to tourists and world business people. According to an estimate, Americans take 93.0 million international outbound trips each year, and 79.6 million international visitors come to the USA. 538 million global tourists visited in 2019 to Europe, which accounts for 50% of the world's total travel.

Currently, there are problems getting short translations. People use automated machine translations. However, they are not as accurate as a live translator, especially for local dialects.

Even though they are getting better, machine translations are not very accurate with slang, idioms, and local dialects.

Listings of live translators are not readily available. Also, ratings and costs for live translators are not readily available. If one does find a listing of translators for translating from one specific language to another, it is generally a guess as to who to use since costs and ratings are not generally published.

One can spend some time finding several translators who can perform the translation, then get costs from each of these and try to find consumer ratings of each translator.

Once translators are chosen, there is the scheduling problem of having all parties meet for the translation. If the translation is in-person, a convenient location must be found. Also, it should be scheduled when all parties are available. This process can get time-consuming and may not be very accurate if your decision is based on small sample sizes.

There is a good deal of ‘overhead’ when hiring a live translator. If the translation job is small, such as a few-minute phone call, it may not be worth hiring a live translator. Therefore, getting a live translator is not typical for short translations.

Since the translator is paid for his/her services, we must also determine an acceptable process for payment. When the parties are not physically near each other, we need a trusted intermediary to ensure that the translations are correctly done, and that payment is properly made. Also, if the parties are in different countries, payment may have to be converted.

Since there is so much overhead ‘setup’ involved each time, a translator is hired, it may not be worth it for translators to take ‘jobs’ that are only a few minutes long.

There have been attempts in the past to provide translation services, such as that described in US 2014/0236566A1 by Reinhard Schreier (“Schreier”). Schreier discloses similarities in a way that it uses programs that connect users to translators based on translator profile data. However, Schreier does not let the users choose a translator. Schreier indicates that a machine automatically chooses a translator for a user based on translators' profile data. Users do not have abilities to choose their translators. Schreier only discloses chat and audio, but not video translations. Schreier also does not disclose how payments, and fees are handled and does not include any trusted intermediates.

Another attempt was made by U.S. Pat. No. 10,025,776 B1 Sjoberg et al. “Sjoberg”). Sjoberg discloses the connection of users to translators based on chat/audio/video requests but does not mention the region or location of the users. There is no way of finding the closest translator. Sjoberg also does not disclose In-Person translation sessions.

Different regions have different dialects. Sjoberg does not account for these differences. Sjoberg also does not disclose how payments and fees are handled and does not include any trusted intermediates.

Sjoberg does not disclose a convenient way for translators to turn on or off their availability. Also, Sjoberg automatically determines the unspecified language from audio input.

Currently, there is a need for a system that can minimize the setup required to acquire a capable live translator, set up a translation session, and handle payments.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead is placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted to facilitate a less obstructed view of these various example embodiments.

FIG. 1A is a simplified block diagram of a current system according to one embodiment of the current invention functioning to onboard translators.

FIG. 1B is a simplified block diagram of the current system shown as it functions to onboard a requester.

FIG. 1C is a simplified block diagram of the current system as it functions to find a list of capable translators to provide to the Requester.

FIG. 1D is a simplified block diagram of the current system as it functions to receive the Requester's choice of a translator.

FIG. 1E is a simplified block diagram of the current system as it functions to link receive an initial payment from the Requester.

FIG. 1F is a simplified block diagram of the current system as it functions to link the Requester and Translator to a common streaming platform.

FIG. 1G is a simplified block diagram of the current system as it functions to provide any refunds to the Requester and make payment to the Translator.

FIG. 1H is a simplified block diagram of the current system as it functions to acquire, and store ratings for the Translator and Requester.

FIGS. 2A and 2B together are a simplified flowchart of the major steps performed by one embodiment of the current invention in setting up and managing a translation session.

### DETAILED DESCRIPTION

At least some of the following exemplary embodiments provide an improved system and method suitable for requesting, automatically configuring, and participating in live video or audio conferences. Many other advantages and improvements will be discussed in more detail below or will be appreciated by the skilled person for carrying out exemplary embodiments based on the teachings herein. The exemplary embodiments have been described particularly in relation to the insurance industry. However, it will be appreciated that the example embodiments may be applied to many other specific uses.

### Theory

As indicated in the Background above, there is considerable overhead involved in trying to find a translator who can translate between two specific languages. It is even more difficult to find such a translator when the language has several different dialects, which can be somewhat different.

There is also the problem of making payments with an unknown remote person. People are reluctant to provide financial information to an unknown person, especially with the amount of fraud that happens on the Internet.

Also, there is a scheduling problem. If the Requester and Translator are in different time zones, a time must be chosen which is acceptable to all parties.

The current invention functions to eliminate or reduce these problems.

### Implementation

A Language Translator System (“System”) 1000 is disclosed that links a live translator (“Translator”) with a person requesting translation (a “Requester”) through a video conversation, phone conversation, or chat session. The System 1000 receives a request for translation by either video call, voice call, or chat session from a Requester device 201. The System 1000 finds several translators capable of performing the translation and provides their information, cost for the translation, and user ratings to the Requester 101 through the Requester device 201. The Requester 101 then selects one of the Translators 402, 403, 405 provided to Requester 101. If the selected Translator 403 accepts, financial module 550 of server 500 acquires financial information from the Requester 101 for an estimated cost for the translation session and charges this initial amount through a trusted financial system. A linking module 570 of server 500 then links the Requester 101 and Requester device 201 to the Translator 403 and Translator device 303 to perform live translations. Once the translation session is finished, the payment from Requester 101 is adjusted, and the Translator 403 is paid.

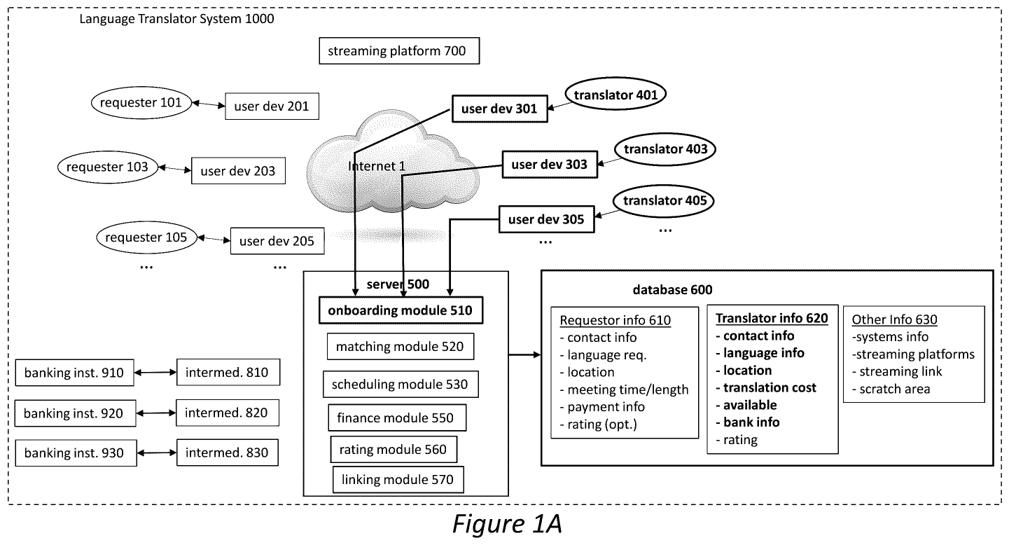

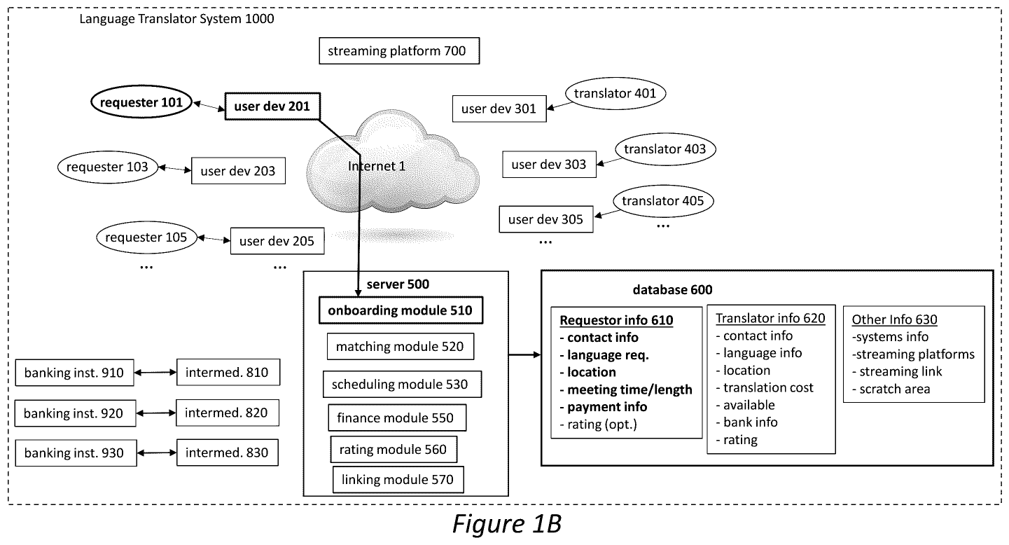

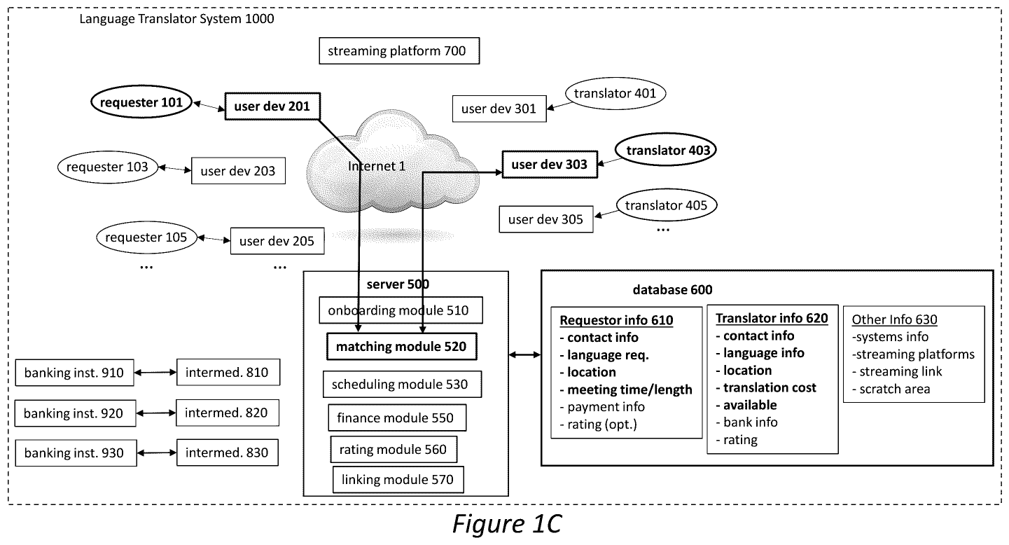

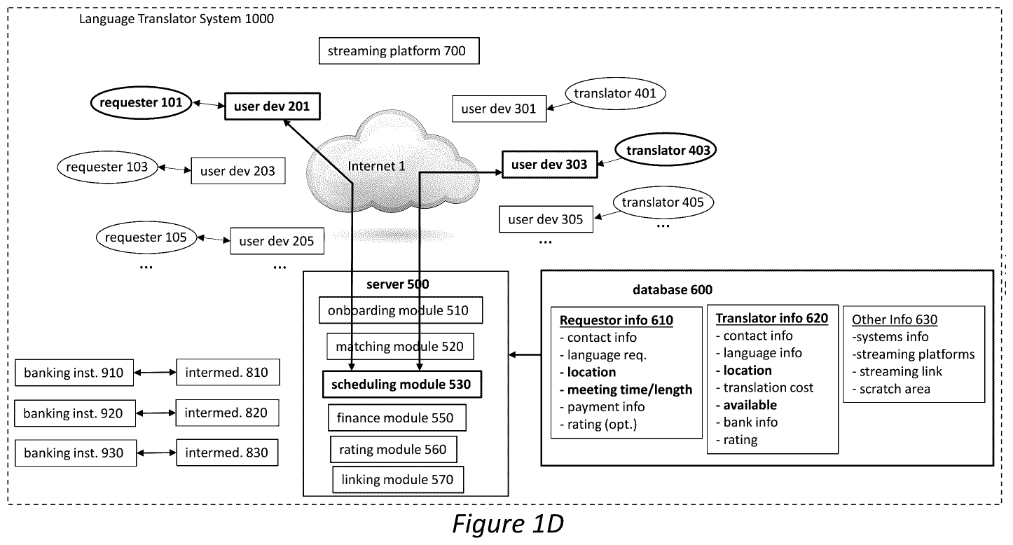

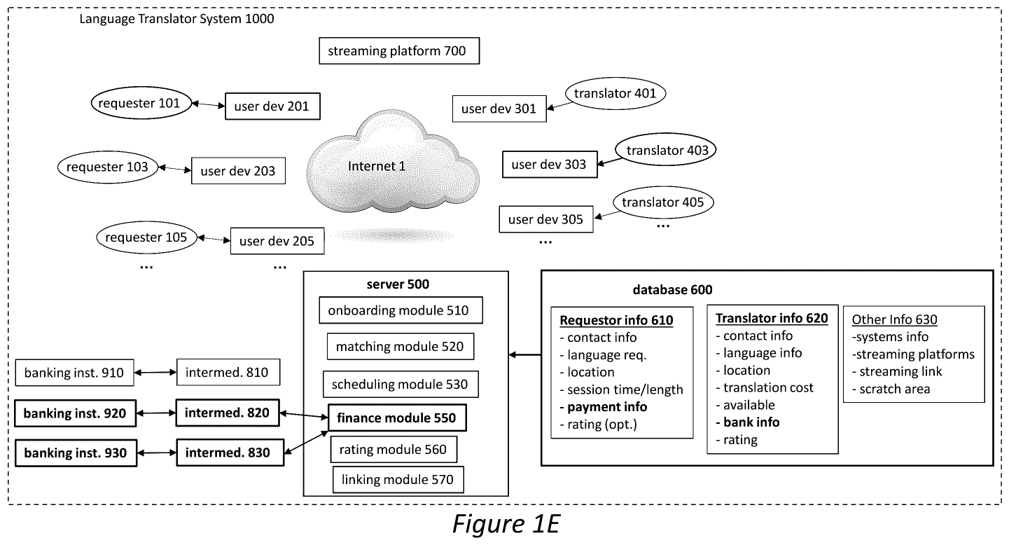

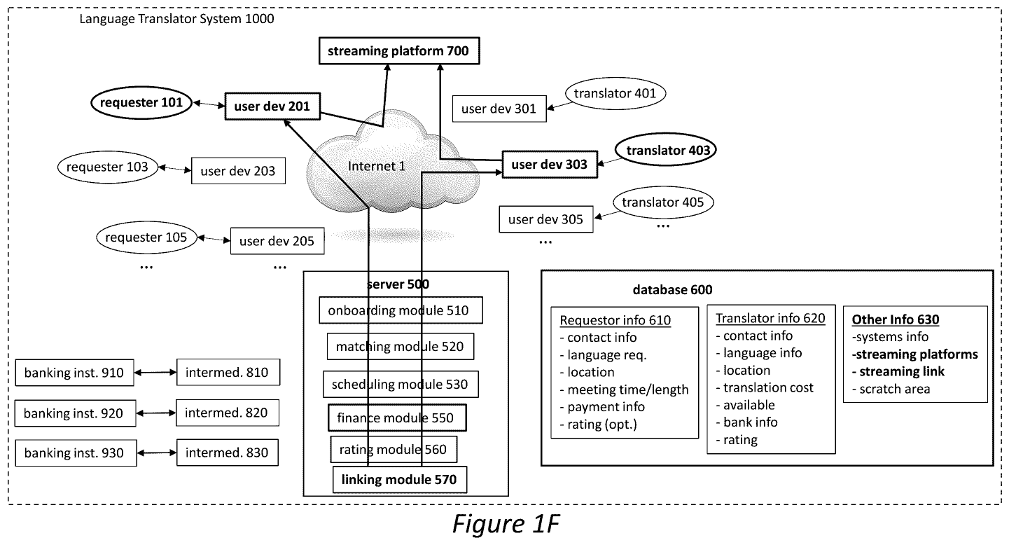

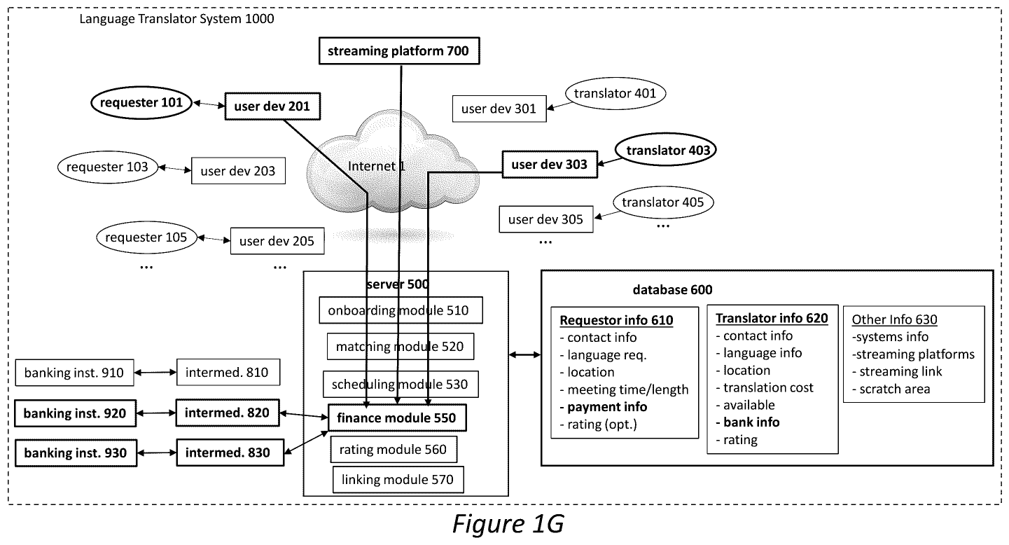

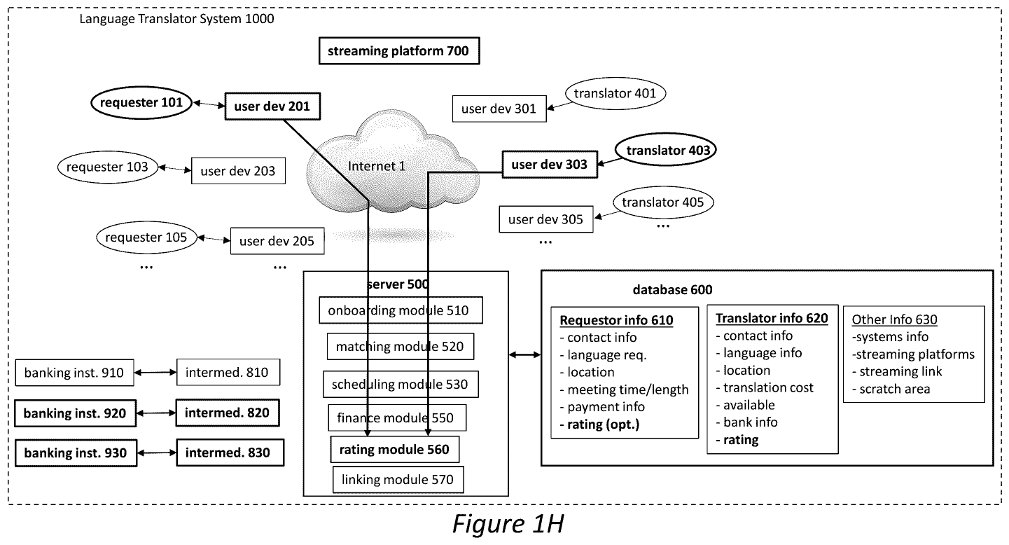

In FIG. 1H, the rating module 560 of server 500, prompts Requester 101 through Requester device 201 for a rating of Translator 403. A rating from Requester 101 is then received by rating module 560 and stored in Translator info 620 of database 600. This rating is merged with past ratings of this Translator to produce an adjusted rating that is presented to Requesters when they are selecting a Translator.

Optionally, the rating module 560 can prompt Translator 403 through Translator Device 303 to provide a rating of Requester 101. This is merged into the rating information for Requester 101 in Requester info 610 of database 600 to get an updated rating. This updated rating is provided to the Translators when the Requester is selecting a Translator.

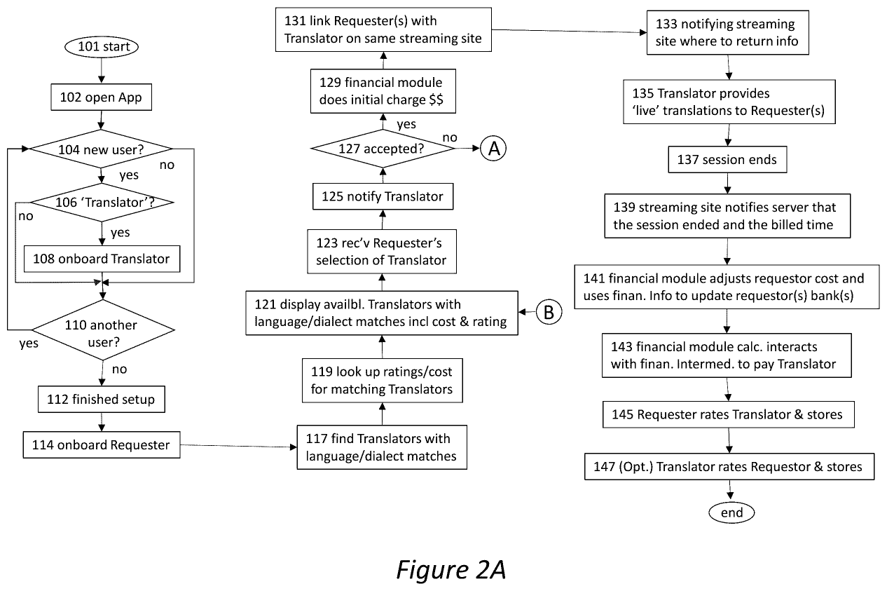

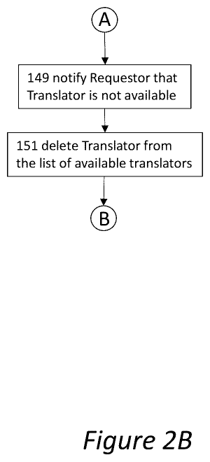

The current system is described in a more detailed description in connection with FIGS. 1A-1H, 2A, and 2B.

FIG. 1A is a simplified block diagram of a system according to one embodiment of the current invention functioning to onboard translators.

The setup process begins in FIG. 2A at block 101 marked “start”.

In block 102, Translators 401, 403, 405 open an App on a user device (“Translator devices”) 401, 403, 405 that contact a server 500 through a network, such as the Internet 1, as shown in FIG. 1A.

An onboarding module 510 of server 500 begins to process the input initial information from Translator devices 301, 303, 305.

In block 104, onboarding module 510 determines if this is a new user that requires a setup. If not, “no”, then processing continues at block 110.

If it is determined that this is a new user, then it is determined in block 106 if the new user is a Translator. If the user is not a Translator, “no”, then processing continues at block 110.

If the new user is a Translator, “yes”, then onboarding module 510 of FIG. 1B acquires information from the new user (FIG. 1B), some of which is shown under “Translator info 620” in database 600. The information acquired may include the Translator's contact information, languages, and dialects that can translate, price per minute, location, the estimated session time, and financial or bank information to receive payment for the translations. The trusted intermediary can be through any number of trusted financial intermediaries, such as Stripe.com.

It is then determined in block 110 if there is another user that should be onboarded. If there are no other users, “no”, then processing continues at block 112.

If there is another user to be onboarded, “yes”, then processing continues at step 104.

In step 104, onboarding module 510 acquires information from the Requester 101 through the Requester device 201. This information will include the Requester's 101, 103, 105 contact information, languages for translation (dialects if applicable), location, the estimated session time, and financial information to pay for the translation.

The System 1000 asks the Requester and Translator to log into an account for a financial intermediary, such as Stripe.com. If a Requester or Translator does not have an account, he/she is required to open one before using financial module 550 of server 500. Financial module 550 may use financial intermediaries 810, 820, 830 to charge the Requester or and pay the Translator.

This setup process is repeated with all new users, both Requesters 101, 103, 105, and Translators 401, 403, 405.

In step 114, the Requester 101 requests a Translator to translate between a first and second language. It is also determined if either of the selected languages is one that requires the selection of a dialect. If so, then matching module 520 of FIG. 1C requests the desired dialect from Requester 101 through Requester device 201.

In step 117, matching module 520 then stores the language (dialect, if necessary) in the Requesters info 610. Matching module 520 then searches the Translator info 620 for the closest matches for the language (and dialect) in FIG. 1C.

In block 119, matching module 520 then looks up the cost that each of the matching Translators charges, their availability, and their past ratings. The list of available Translators and their information are then presented to Requester 101 through Requester device 201 in block 121.

In one embodiment, the Translators can flip a switch, or press a button on their App, indicating if they are currently available to accept translations or not. The availability switch can be toggled as many times as the Translator would like to do so. It allows immediate indication of the Translator's 403 availability. Since availability can be turned on or off immediately, Translators can constantly pick up small jobs to make money when they have free time.

In one embodiment, a new Translator with no reviews will be listed as having no reviews. In an alternative embodiment, a new Translator starts with the group average. This number then moves up or down depending on the ratings received.

In block 123, scheduling module 530 of FIG. 1D receives the selection of Requester 101, which is Translator 403. Scheduling module 530 notifies Translator 403 in block 125 that Requester 101 has requested that Translator 403 translate in a session.

If Translator 403 accepts the translation session in block 127, then block 129 is executed.

In block 129, financial/rating module 550 of FIG. 1E requests a security code for a credit card of the Requester's account stored in the financial intermediary 820 to acquire payment for the cost of the session based upon the requested session length. (The financial intermediary 820 may then charge a banking institution 920.)

In block 131, A session is scheduled and linking module 570 of FIG. 1F provides the linking information to have user device 201 and Requester 101 connect to the same streaming platform 700 as user device 401 and Translator 403. Linking module 570 also indicates an address to send information on the translation session in block 133.

If it is not an immediate session, scheduling module 530 interacts with the Requester and Translator to put the Requester on the waiting list of the Translator or match the Requester with another Translator.

In block 137, the translation session ends.

In block 139, streaming platform 700 notifies the finance/rating module 550 that the translation session ended and reports the billed translation session time.

In block 141, if the session ends earlier than the requested time, then financial/rating module 550 will refund the extra amount held from the Requester's card by the financial intermediary 820.

In block 143, the financial/rating module 550 also effectuates payment to the Translator 403 through another financial intermediary 830. (This intermediary may deposit money into a banking institution 930.)

There may be other financial intermediaries 810 for other Requesters and Translators. These may also further interact with other banking institutions, such as banking institution 910.

In block 145 the Requester rates the Translator on their translation session. This is then stored by the financial/rating module 550 in database 600 in the section Translator info section 620. (This the rating provided to Requesters at the beginning of the process when choosing a Translator.)

Optionally, in block 147, the Translator can rate the Requester. This is then stored in database 600, in section Requester info 610. This rating may optionally be provided to the Translators before accepting the translation session.

The process then ends after step 147.

In step 127, if the Translator does not accept the translation session “no”, then block 149 of FIG. 2B is executed. In block 149, the Requester is notified that the chosen Translator did not accept the translation session.

In block 151, this Translator is deleted from the list of able Translators that is provided to the Requester and processing continues at block 121 of FIG. 2A, provided that there are other Translators available. If there are none, then the process ends.

Although a few examples have been shown and described, it will be appreciated by those skilled in the art that various changes and modifications might be made without departing from the scope of the invention, as defined in the appended claims.

What is claimed is:

1. A language translator system, that links a live translator (“Translator”) through a Translator device with a user (“Requester”) using a Requester device to remotely perform live translations, comprising:
a. a plurality of user (“Translator”) devices adapted to run executable software (“Apps”) and interface with a Translator and communicate with a remote server to set up an account with the server;
b. a plurality of user (“Requester”) devices adapted to run executable software (“Apps”) and interface with a Requester, and communicate with a remote server to set up an account with the server;
c. a streaming platform capable of facilitating communication between two connected users;
d. a server 500 adapted to communicate with the Requester devices and the Translator devices, wherein the server functions to:
i. receive a request for a translation from a first language to a second language from the Requester through Requester device;
ii. search a preloaded database to identify Translators that have the ability to perform the translation;
iii. display information of the able Translators to the Requester 101 on Requestor's device;
iv. receive the Requester's selection of a Translator;
v. notify the Translator device that the Translator was chosen by the Requester to perform a translation and ask if the Translator is willing to perform the translation;
vi. receive the Translator's response;
vii. if the selected Translator does not accept the translation, then repeat steps “iii” through “vii” and omit the Translators who are not willing to perform the translation;
viii. if Translator accepts the translation, charge the financial account of the Requester for an estimated translation period;
ix. link the chosen Translator device and the Requester device to a streaming platform to have a ‘live’ translation session between the Requester and Translator;
x. notify the streaming platform to notify server when the translation session has finished, along with the length of the translation session;
xi. receive the length of the translation session from streaming platform, calculate the charge to the Requester and return any overpayment by the financial account of the Requester;
xii. cause payment to a financial account of the Translator;
xiii. prompt Requester through the Requester device for a rating of the Translator;
xiv. receive the Translator's rating from Requester device;
xv. store the Translator's rating in database; and
xvi. provide Translator's rating upon request.

2. The language translator system of claim 1 wherein the server further functions to:
a. prompt the Translator device for a rating of the Requester;
b. receive the rating from Translator device;
c. store the Requester's rating in database; and
d. provide Requester's rating upon request.

3. The language translator system of claim 1 where the server causes payment to a financial account of the Translator through a trusted intermediary.

4. The language translator system of claim 1 wherein the streaming platform hosts a translation session is at least one of a) an interactive video session, b) an interactive audio session, or c) an interactive chat session.

5. The language translator system of claim 1 wherein the Translator has the interactive ability to cause the Translator device to identify the Translator as ‘available’ or ‘not available’ for translation at specified days and times.

6. A language translator system for linking a user (“Requester”) requesting a translation between a first language and a second language with a Translator capable of translating between the first and second languages, comprising:
a. a plurality of Requester devices, each capable of communicating with an associated Requester and a server;
b. a plurality of Translator devices, each capable of communicating with an associated Translator and a server;
c. a streaming platform capable of facilitating communication between two connected users;
d. a server capable of interacting with the translator devices to onboard and store information of their associated Translators;
e. wherein the server is also capable of interacting with the Requester devices to onboard and store information of their associated Requesters;
f. wherein the server receives translation requests from a Requesters device, determines capable Translators from the onboarded information and displays information of the capable Translators on the Requester device;
g. wherein the server functions to receive a selection of one of the capable Translators from Requesters device;
h. a financial module in the server that charges for a translation session to a financial account of the Requester;
i. a scheduling module that interacts with the Requester through Requester device and the selected Translator through Translator device to select a time and mode for a translation session;
j. a streaming platform capable of passing at least one of audio, video or chat messages between two connected users;
k. a linking module in server that links both the Requester device and the selected Translator device to the same streaming platform for the translation session allowing communication between the Requester and the Translator; and
l. a rating module in the server that interacts with the Requester to acquire the Requester's rating of the Translator.

7. The language translator system of claim 6 wherein the rating module is further adapted to interact with the Translator through the Translator device to acquire the Translator's rating of the Requester.

8. The language translator system of claim 6 where the server causes payment to a financial account of the Translator through a trusted intermediary.

9. The language translator system of claim 6 wherein the streaming platform hosts a translation session that is at least one of a) an interactive video session, b) an interactive audio session, or c) an interactive chat session.

10. The language translator system of claim 6 wherein the Translator has the interactive ability to cause the Translator device to identify the Translator as ‘available’ or ‘not available’ for translation at specified days and times.

11. A method of linking a user requesting translation (“Requester”) to a user performing the translations (“Translator”), comprising the steps of:
a. connecting a plurality of Translators through Translator devices to a server having an onboarding module;
b. acquiring and storing onboarding information from the Translators;
c. receiving a request from a Requester through a Requester device at the server, for a translation from a first language to a second language;
d. requesting and storing information of the Requester;
e. determining which Translators are capable of performing the requested translation;
f. providing stored information of the capable Translators to the Requester on Requester device;
g. receiving a selection of a Translator by the Requester at the server;
h. notifying the Translator that he/she has been selected for a specified date/time;
i. receiving Translator response if he/she is available at the date/time selected;
j. if selected Translator is not available for the translation session, then processing continues at step “e” above, but the unavailable Translator is not displayed to the Requester 101 in step “f”;
k. selected Translator and Requester are both connected to a same streaming platform, in the same translation session allowing communication between them;
l. after the translations session ends, streaming platform sends the length of the session to server;
m. a financial module of server charging a financial account of the Requester at a banking institution for the translation session;
n. a financial module of server paying a financial account of the Translator at a banking institution for the translation session; and
o. the server prompting the Requester to rate the Translator merging this rating with any past ratings and providing the merged rating along the next time this Translator's information is provided according to step “f” above.

12. The method of claim 11 further comprising the step of:
a. prompting the Translator to rate the Requester, receiving and merging this rating with any past ratings of Requester, and providing the merged rating to the capable Translators the next time this Translator's information is provided according to step “f” above.

13. The method of claim 11 wherein the rating module is further adapted to interact with the Translator through the Translator device to acquire the Translator's rating of the Requester.

14. The method of claim 11, wherein the server causes payment to a financial account of the Translator through a trusted intermediary.

15. The method of claim 11, wherein the streaming platform hosts a translation session that is at least one of a) an interactive video session, b) an interactive audio session, or c) an interactive chat session.

16. The method of claim 11, wherein the Translator has the interactive ability to cause the Translator device to identify the Translator as ‘available’ or ‘not available’ for translation at specified days and times.
